(19) United States
(12) Patent Application Publication
(10) Pub. No.: US 2012/0256800 A1
(43) Pub. Date: Oct. 11, 2012

(54) MULTIBAND ANTENNA STRUCTURE AND METHODS

(76) Inventor: Reetta Kuonanoja, Oulu (FI)

(21) Appl. No.: 13/514,939

(22) PCT Filed: Dec. 8, 2010
(86) PCT No.: PCT/FI2010/051003

§ 371 Date: Jun. 8, 2012

(30) Foreign Application Priority Data
Dec. 14, 2009 (FI) 20096320

(51) Int. Cl. H01Q 5/01

(52) U.S. Cl. 343/749; 343/860; 343/852; 343/850; 343/700 MS

(57) ABSTRACT

An antenna structure intended for small-sized mobile terminals. In one embodiment, the antenna structure comprises a main radiator for implementing the lowest operating band and other radiators for implementing at least one operating band in the high band. The structure also comprises a matching circuit, by which a plural (e.g., double) resonance is implemented for the main radiator in the range of the lowest operating band and the isolation is improved between the main radiator and another radiator. A reactive element is joined to the main radiator so that its electric size decreases in the high band and increases in the low band. The former strengthens the resonances in the high band, and thus results in rise in the efficiency in the high band.

The invention relates to a multiband antenna structure, intended especially for small mobile terminals.

In the mobile terminals fitting into the pocket the antenna is usually placed inside the covers of the device, in which case the small space available complicates the antenna design. The difficulty increases remarkably, when the device must be able to function in accordance with several radio systems, such as different GSM systems (Global System for Mobile telecommunications). The smallness of the device's ground plane, which at the same time is the antenna's ground plane, is one degrading factor in the antenna function especially in the range below the frequency 1 GHz.

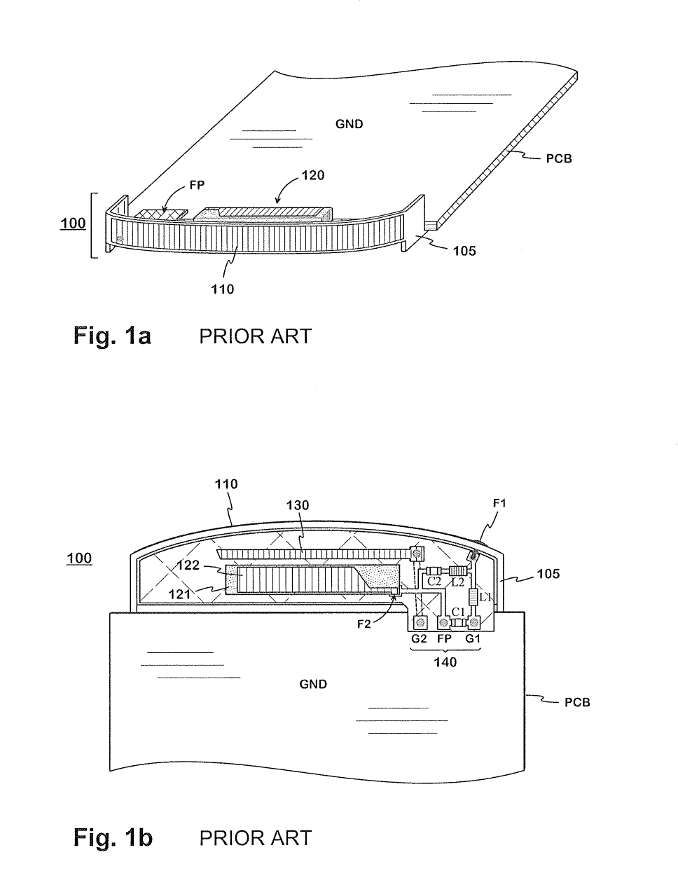

The solution, which meets the requirements, has inevitably relatively complex radiator structure or more than one separate partial antennas. FIGS. 1a and 1b show an example of such a multiband antenna, known from the publication WO 2008/081077. The antenna structure is seen from the front as a perspective drawing in FIG. 1a and from above in FIG. 1b. The antenna structure is located at an end of the circuit board PCB of a radio device, outside the circuit board. The upper surface of the circuit board is mostly of conductive ground plane GND. The structure comprises three radiators. The first radiator 110 is in its width direction vertical conductor strip on the outer surface of a support frame 105 fastened to the end of the circuit board. The second radiator 122 is of conductor coating of an oblong ceramic substrate 121. These constitute an antenna component 120, which is located on a horizontal plate-like portion belonging to the frame 105, closer to the circuit board than the first radiator 110. The third radiator 130 is a parasitic conductor strip between the antenna component 120 and first radiator 110 and is connected from its one end to the ground plane at the grounding point G2. By the first radiator is implemented the lower operating band of the antenna structure and by the second and third radiator the higher operating band.

The antenna structure shown in FIGS. 1a and 1b further comprises a matching circuit 140. This includes a first C1 and second C2 capacitor and a first L1 and second L2 coil. The first capacitor is connected from the feed point FP of the whole antenna structure to the ground GND at the grounding point G1. The second capacitor and second coil are in series between the feed point FP and the feed point F1 of the first radiator. The first coil L1 again is between the feed point F1 and the ground. The feed point FP is also connected to the feed point F2 of the second radiator by a conductor strip. The feed end of this radiator is narrower than the rest of the radiator, in which case extra inductance springs up in the starting end with the intention of matching.

The second capacitor C2 and second coil L2 form a serial resonance circuit which has the effect that the first radiator 110 has a double resonance instead of one resonance. The lower operating band is based on these resonances. Their frequencies are arranged suitably close to each other so that the lower operating band becomes relatively wide.

The above-mentioned serial resonance circuit constitutes at the same time and together with the ground plane a bandpass filter between the feeds of the first and second radiator. The lower operating band of the antenna structure is located in the filter's pass band, but the higher operating band in the stop band. The attenuation at the frequencies of the higher operating band is high, which means improvement in the isolation between the first and second radiator so that said common feed point FP can be used for them.

The antenna structure presented in FIGS. 1a and 1b constitutes an integrated antenna module 100 which can be tested separately and mounted then in a radio device.

The antenna's operating bands covering the frequency ranges of different GSM systems and WCDMA2100 system (Wideband Code Division Multiple Access) can be achieved by means of the above-described solution. However, if the device has to function also e.g. in the WCDMA7 system, the frequency range of which is 2500-2690 MHz, the solution is not sufficient. Also the band 698-798 MHz defined in the LTE standard (Long Term Evolution) will not be covered at least without several extra components.

An object of the invention is to reduce said drawbacks of the prior art. An antenna structure according to the invention is characterized by what is set forth in the independent claim 1. Some advantageous embodiments of the invention are disclosed in the other claims.

The basic idea of the invention is as follows: The antenna structure comprises a main radiator for implementing its lowest operating band in the low band and other radiators for implementing at least one operating band in the high band. The structure comprises also a matching circuit, by which a double resonance is implemented for the main radiator in the range of the lowest operating band and the isolation between the main radiator and another radiator is improved. A reactive element is joined to the main radiator so that its electric size decreases in the high band and increases in the low band. The former matter strengthens the resonances in the high band.

In this description and the claims the ‘low band’ means the frequency range down from the frequency 1 GHz, and the ‘high band’ means the frequency range up from the frequency 1.7 GHz.

An advantage of the invention is that the function of a small-sized antenna structure improves at least in the high band. This is due to the fact that the reactive element joined to the main radiator causes efficiency rise in one or two operating bands lying in the high band because of the strengthening of the resonances. At the same time the usable frequency range widens in the high band. Also the operating band in the low band widens especially when an inductance is used as said reactive element. In addition, an expedient known as such can be utilized in the antenna structure to constitute a double resonance in the lower operating band for further widening this band.

In the following, the invention is described in closer detail. In the description, reference is made to the accompanying drawings in which

FIGS. 1a,b present an example of the known multiband antenna,

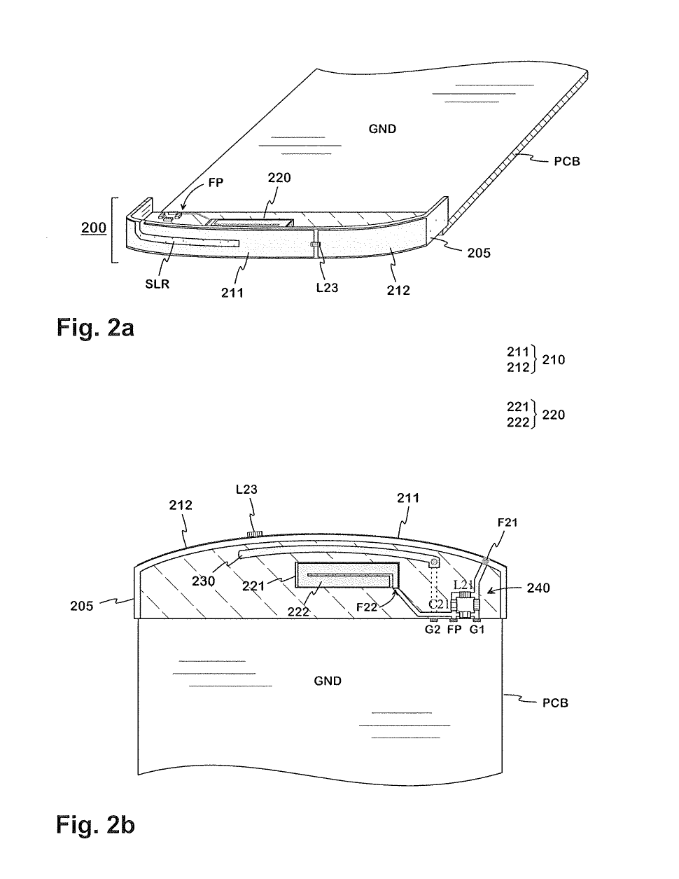

FIGS. 2a,b present an example of the antenna structure according to the invention,

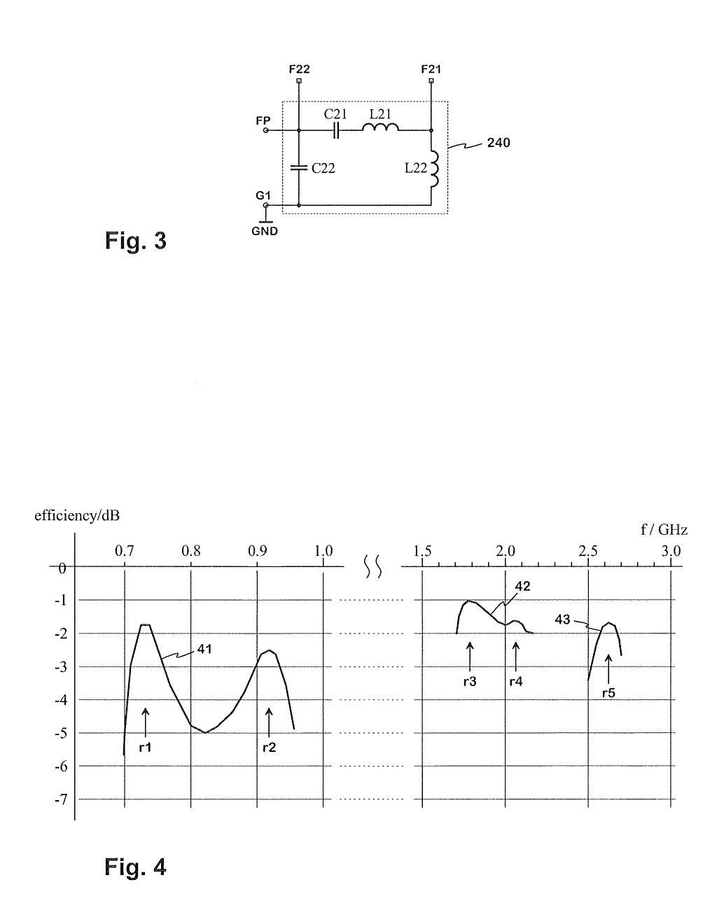

FIG. 3 presents an example of the matching circuit of the antenna structure according to the invention,

FIG. 4 presents an example of the efficiency of the antenna structure according to FIGS. 2a and 2b,

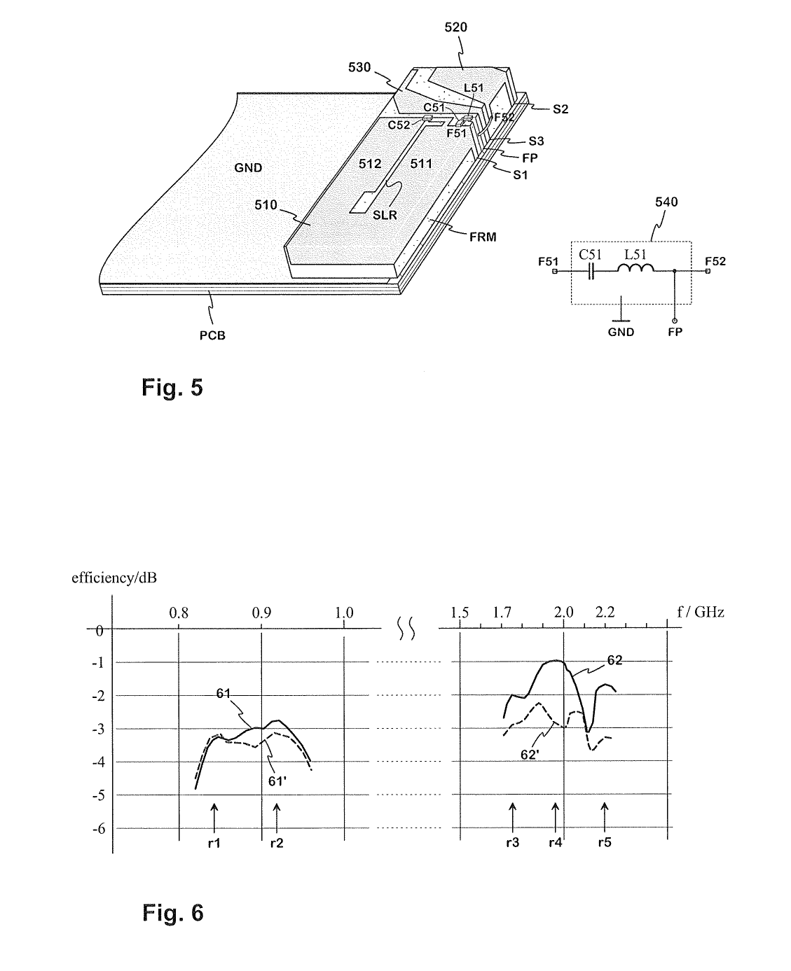

FIG. 5 presents another example of the antenna structure according to the invention, and

FIG. 6 presents an example of the efficiency of the antenna structure according to FIG. 5.

FIGS. 1a and 1b were already described in connection with the description of prior art.

In FIGS. 2a and 2b there is an example of the multiband antenna structure according to the invention. It is located at an end of the circuit board PCB of a radio device, outside the board, and is seen in FIG. 2a from the front as a perspectice drawing and in FIG. 2b from above, or from the side of the ground plane, perpendicularly to it. The upper surface of the circuit board is mostly of signal ground GND of the radio device, which functions also as the ground plane of the partial antennas. The antenna structure has three separate operating bands: lowest, higher and highest operating band, the lowest one of which is located in the low band and the latter two in the high band. The structure comprises four radiators: main radiator 210, second radiator 222, parasitic radiator 230 and slot radiator SLR. The lowest operating band is implemented by the main radiator 210. It is an oblong two-part conductor strip on the outer surface of a support frame 205 fastened to the end of the circuit board PCB. The main radiator is lengthwise about as long as the circuit board's end side and its width direction is vertical, or perpendicular to the geometric plane determined by the ground plane. The support frame 205 is relatively thin at the main radiator, in which case the main radiator is mostly air-insulated. This means minor dielectric losses and thus good efficiency in the lowest operating band.

The second radiator 222 is of conductor coating of a ceramic substrate 221. Together, they constitute a chip component 220 which is located on the horizontal plate-like portion belonging to the frame 205, closer the circuit board PCB than the main radiator. The parasitic radiator 230 is a conductor strip on the surface of the frame 205 between the chip component 220 and the main radiator 210. It is connected from its one end to the ground plane GND at the grounding point G2. By the chip component 220 and the parasitic radiator 230 is implemented the higher operating band of the antenna structure which is located around the frequency 2 GHz.

By the slot radiator SLR is implemented in this example the highest operating band of the antenna structure which is located above the frequency 2.5 GHz. The slot radiator has been made into the first part 211 of the two-part main radiator. Most of the radiating slot has the same direction as the main radiator, and opens to the upper edge of the main radiator next to its feed point F21.

The main radiator 210 is two-part so that it comprises the first 211 and second 212 part, between which there is a relatively narrow non-conductive gap. The first and second part are coupled by an inductive element L23, the impedance of which is relatively high at the frequencies of the high band. This kind of arrangement has a meaning both in the low and high band. In the high band the effect is that at its frequencies the electric size of the main radiator decreases because of the above-mentioned impedance. This results in that the resonances of the antenna structure in the high band, i.e. the resonances of the second radiator, parasitic radiator and slot radiator, strengthen. This further results in that the efficiency of the structure improves in the operating bands corresponding to these resonances, and in addition these operating bands widen. In the low band the effect of the division of the main radiator is that at its frequencies the electric size of the main radiator increases because of the inductance of the inductive element. The use of a serial inductance is an old way to increase the electric size of a radiator at its resonance frequency. The increase of the main radiator causes its lowest resonance frequency to lower. This helps to widen the lowest operating band downwards. In the example structure the lowest operating band is extended to the lower boundary of the LTE700 system's frequency range 698-798 MHz.

The inductive element L23 is in this example a surface-mounted coil. Its inductance is for example 22 nH.

The antenna structure shown in FIGS. 2a and 2b further comprises a matching circuit 240. Two capacitors and two coils of the matching circuit are visible in FIG. 2b, which all are in this example surface-mounted components on the surface of the frame 205. The matching circuit is connected to the feed point FP of the whole antenna structure and to the ground plane GND at the grounding point G1. In addition, the matching circuit is connected to the main radiator 210 at its feed point F21 and to the second radiator 222 at its feed point F22. The matching circuit will be described in greater detail in the following.

The parts of the antenna structure constitute an integrated antenna module 200, which can be tested separately and then mounted in a radio device.

In FIG. 3 there is as a circuit diagram an example of the matching circuit 240 of the antenna structure according to the invention. It comprises a first C21 and second C22 capacitor and a first L21 and second L22 coil. The first capacitor C21 and the first coil L21 are in series thus constituting a serial resonance circuit. This is connected between the feed point FP of the antenna structure and the feed point F21 of the main radiator. The serial resonance circuit has the effect that the main radiator 210 has a double resonance instead of one basic resonance in the lowest operating band. The frequencies of these resonances are arranged so that the loweroperating band becomes relatively wide but, even so, united.

The second capacitor C22 is connected between the feed point FP of the antenna structure and the grounding point G1. The impedances of the partial antennas based on the second radiator 222 and the parasitic radiator 230 are matched by means of the second capacitor. The second coil L22 is connected between the feed point F21 of the main radiator and the grounding point G1. The impedance of the partial antenna based on the main radiator is matched by means of the second coil.

The feed point FP of the antenna structure is also connected directly to the feed point F22 of the second radiator. This results in that the matching circuit constitutes a bandpass filter between the port represented by the feed point of the second radiator and grounding point G1 and the second port represented by the feed point of the main radiator and grounding point G1. The lowest operating band of the antenna is located in the filter's passband, and the attenuation from the first port to the second port is significantly high at the frequencies of the higher operating band. This means improvement in the isolation between the said radiators so that the shared feed point FP can be used for the radiators in the antenna structure.

FIG. 4 shows an example of the efficiency of an antenna structure according to FIGS. 2a and 2b. The component values of the matching circuit are: C21=0.7 pF, L21=30 nH, C22=0.7 pF and L22=1 nH. The value of inductance, which couples the parts of the main radiator, is 22 nH. The curves show the fluctuation of the efficiency as the function of frequency, when the antenna is in free space. The efficiency value 0 dB corresponds to the ideal case, in which no losses occur. Curve 41 shows the fluctuation of the efficiency in the lowest operating band, which is 698-960 MHz. It is seen that the efficiency varies between the values −1.8 dB and −5.0 dB. Curve 42 shows the fluctuation of the efficiency in the higher operating band, which is 1.7-2.17 GHz. It is seen that in this range the efficiency varies between the values −1.0 dB and −2.0 dB, which is an excellent result. Curve 43 shows the fluctuation of the efficiency in the highest operating band, which is 2.50-2.69 GHz. It is seen that in this range the efficiency varies between the values −1.6 dB and −3.3 dB, which also is a good result.

The resonance points of the antenna structure can be seen from the locations of the peaks in the efficiency curves, because the antenna naturally radiates most effectively in a resonance. The lowest operating band is based on the first r1 and second r2 resonances which form said double resonance. The former one is located at about the point 730 MHz and the latter one at about the point 920 MHz. The distance is notably long, for which reason the efficiency falls therebetween to the value −5 dB. However, the lowest operating band has been accomplished to cover the frequency ranges of the systems LTE700, GSM850 and GSM900, which is an excellent achievement. The higher operating band is based on the third r3 and fourth r4 resonances. The former of these is the resonance of the parasitic radiator and is located at about the point 1.78 GHz. The fourth resonance r4 is the resonance of the chip component 220 and the second radiator in it and is located at about the point 2.06 GHz. The higher operating band covers the frequency ranges of the systems GSM1800, GSM900 and WCDMA2100. The highest operating band is based on the fifth resonance r5. This is the resonance of the slot radiator and is located at about the point 2.62 GHz. The highest operating band covers the frequency range of the system WCDMA7.

FIG. 5 shows another example of the multiband antenna structure according to the invention. It is located at an end of the circuit board PCB of a radio device. The upper surface of the circuit board is mostly of signal ground GND of the radio device, which functions also as the ground plane of the partial antennas. The antenna structure has in this example two separate operating bands: lower and higher operating band, the former of which is located in the low band and the latter in the high band. The structure comprises a dielectric support frame FRM, which is a housing on the circuit board PCB with relatively thin walls and radiators which are of conductive coating of the support frame. The number of conductor radiators is three: main radiator 510, second radiator 520 and parasitic radiator 530. In addition the radiating structure comprises a slot radiator SLR which has been implemented in the main radiator.

The main radiator 510 coats largely the upper surface of the support frame extending also a distance to the front surface and first head surface of the frame FRM. The ‘front surface’ means here the outer one, seen from the middle of the circuit board, of the frame's surfaces parallel with the end side of the circuit board. The main radiator comprises a first part 511 and as its continuation a last part 512. The first part is mostly located on the upper surface of the frame, on the side of the front surface. It starts from the feed point F51 of the main radiator and extends to the first end of the frame. The last part 512 is mostly located on the upper surface of the frame, on the side of the rear surface, extending beside the first part 511 from the first end of the frame next to the starting end of the first part. The main radiator 510 is connected to the ground plane GND at the first short-circuit point S1 close to the feed point FP of the antenna structure. These points are located under the frame FRM on the side of the front surface. The ground plane extends on the circuit board PCB below the main radiator, in which case the partial antenna constituted by the ground plane and main radiator is of PIFA type (Planar Inverted-F Antenna). Said lower operating band of the antenna structure is implemented by the main radiator.

A relatively narrow slot SLR remains between the first and last parts of the main radiator, which slot opens to the edge of the conductor area between the starting end of the first part and tail end of the last part. This slot is dimensioned so that an oscillation is excited in it, in other words it is a slot radiator. It is used in this example for widening upwards the higher operating band of the antenna structure.

The second radiator 520 is located at the second end of the frame FRM extending from the frame's upper surface a distance to the front surface and second head surface. The second radiator is connected on the front surface from its feed point F52 to the feed point FP of the whole antenna structure and from its another point to the ground plane GND at the second short-circuit point S2. The lowest range of the higher operating band of the antenna structure is implemented by the second radiator. The parasitic radiator 530 is located on the upper surface of the frame between the main 510 and second radiator 520. It is connected from its one end to the ground plane GND at the third short-circuit point S3 which is next to the feed point FP so that the latter point is located between the short-circuit points S1 and S3. The mid range of the higher operating band of the antenna structure is implemented by the parasitic radiator.

As mentioned, the starting end of the first part and tail end of the last part of the main radiator 510 are relatively close to each other. In accordance with the invention, a capacitive element C52 is located between them, the capacitance of which element then exists between the starting end of the first part and tail end of the last part. Such a capacitive coupling decreases the electric size of the main radiator at the frequencies of the high band. This results in that the resonances of the antenna structure in the high band, i.e. the resonances of the second radiator 520, parasitic radiator 530 and slot radiator SLR, strengthen. This further results in that the efficiency of the structure improves in the higher operating band, and in addition this operating band widens. In the low band the effect of said capacitive coupling is relatively slight. In principle, it increases the electric size of the main radiator at its resonance frequency. The capacitive element C52 is in this example a surface-mounted capacitor. Its capacitance is for example 0.5 pF.

The antenna structure shown in FIG. 5 comprises also a matching circuit 540, in which there are a capacitor C51 and a coil L51 on the upper surface of the frame FRM. They constitute a serial resonance circuit between the feed point F51 of the main radiator and the feed point F52 of the second radiator. The feed point FP of the whole antenna structure connects galvanically to the latter point and thus through the serial resonance circuit to the feed point F51 of the main radiator.

FIG. 6 shows an example of the efficiency of an antenna structure according to FIG. 5 in free space. Curve 61 shows the fluctuation of the efficiency in the lower operating band. It is seen that the efficiency varies between the values −2.7 dB and −4.8 dB. Curve 62 shows the fluctuation of the efficiency in the higher operating band. It is seen that the efficiency varies in this band between the values −1.0 dB and −3.1 dB.

Also the resonance points of the antenna structure can be seen in the efficiency curves. The resonances r1 and r2 of the main radiator are located at about the points 840 MHz and 920 MHz. The third resonance r3, which is the resonance of the parasitic radiator, is located at about the point 1.74 GHz. The fourth resonance r4, which is the resonance of the second radiator 520, is located at about the point 1.95 GHz. The fifth resonance r5, which is the resonance of the slot radiator, is located at about the point 2.2 GHz. The lower operating band, based on the resonances r1 and r2, covers the frequency range 824-960 MHz used by the systems GSM850 and GSM900 in all. The higher operating band, based on the resonances r3, r4 and r5, covers the frequency range 1710-2170 MHz used by the systems GSM1800, GSM900 and WCDMA2100 in all.

For comparison, FIG. 6 shows the efficiency curves 61′ and 62′ of the antenna structure, which is like the one in FIG. 5 with the difference that it includes neither the capacitor C52 connecting to the main radiator nor the matching circuit 540. Instead, on the circuit board there is a diplexer, by which the signals in the lower and higher operating band are separated and the main radiator and second radiator are fed separately. It is seen from the curves that especially in the higher operating band a better result is achieved by means of the structure according to the invention although the number of the added components is smaller than the number of the components used in the diplexer.

An antenna structure according to the invention has been described above. In the details, the shapes and locations of the parts of the structure can naturally differ from what is presented. The antenna's ground plane can in each embodiment extend under the radiators or not do so. The capacitive elements can be implemented also by bare conductor strips close to each other on a dielectric base surface, and the inductive elements can be implemented also by a bare narrow conductor strip on a dielectric substrate. A strip having a low inductance can be in series with the discrete coil which strip is used as a tuning element by working it with e.g. a laser at the testing stage. The inventive idea can be applied in different ways within the scope set by the independent claim 1.

1.-8. (canceled)

9. A multiband antenna apparatus, comprising:
a first radiator configured to resonate in a low frequency band;
a second radiator configured to resonate in a high frequency band; and
a matching circuit in communication with a feed point and at least the first radiator and the second radiator, the matching circuit configured to cause a plural resonance in the first radiator in the low band.

10. The apparatus of claim 9, wherein the first radiator comprises a plurality of radiator elements, at least two of the plurality of elements coupled by a reactive element.

11. The apparatus of claim 10, wherein the reactive element comprises an inductance and reduces an electric size associated with the first radiator in the high frequency band, the reduction in electric size strengthening said resonance in the high frequency band.

12. The apparatus of claim 9, wherein the matching circuit comprises at least first and second ports associated with the first and second radiators, respectively, the matching circuit configured to produce enhanced isolation between the first and second radiators.

13. The apparatus of claim 9, wherein the matching circuit comprises at least first and second ports associated with the first and second radiators, respectively, the matching circuit configured to produce enhanced isolation between the first and second radiators.

14. Multiband antenna apparatus for use in a small form factor mobile device, the apparatus comprising:
a first radiator configured to resonate in a first frequency band;
a second radiator configured to resonate in a second frequency band, the second frequency band being lower in frequency than the first band, the second radiator comprising at least first and second radiator elements coupled by a reactive element, the coupling at least in part causing reinforcement of said resonance of the first radiator in the first band; and
circuitry in communication with at least the first radiator and the second radiator, the circuitry configured to cause a plural resonance in the second radiator in the second band, said plural resonance enhancing usable frequency band width in said second band.

15. The apparatus of claim 14, wherein the reinforcement of said resonance of the first radiator produces an increase in efficiency of the apparatus in the first band.

16. The apparatus of claim 15, further comprising a parasitic radiator disposed proximate at least one of said first and second radiators and configured to radiate in the first band.

17. The apparatus of claim 14, wherein the reactive element comprises an inductance, said inductance having a high impedance at least at frequencies within said first band.

18. The apparatus of claim 14, wherein said plural resonance comprises resonance that extends to at least a lower boundary of a frequency range specified in a Long Term Evolution (LTE) wireless standard.

19. The apparatus of claim 18, wherein said lower boundary of a Long Term Evolution (LTE) frequency range comprises 698 MHz.

20. The apparatus of claim 18, wherein said first and second radiators are disposed substantially proximate one another at or near an end of a substantially rectangular housing of the small form-factor mobile device.

21. A method of operating an antenna apparatus comprising a low frequency band radiator and at least one high frequency band radiator, the method comprising:
feeding a signal via a common feed of the antenna apparatus that is coupled to a first feed point associated with the at least one high frequency band radiator, and coupled through circuitry to a second feed point associated with the low frequency band radiator; and
using at least a portion of said circuitry, band-pass filtering said signal so as to pass only any portions of said signal substantially within the low frequency band to said second feed point, and substantially attenuating any portions of said signal substantially above the low frequency band.

22. A high isolation multi-band antenna, comprising:
a low frequency band radiator;
at least one high frequency band radiator; and
a common feed that is (i) coupled to a first feed point associated with the at least one high frequency band radiator, and (ii) coupled through circuitry to a second feed point associated with the low frequency band radiator;
wherein said circuitry is configured to band-pass filter a signal applied to said common feed so as to pass only any portions of said signal substantially within the low frequency band to said second feed point, and substantially attenuate any portions of said signal substantially above the low frequency band, said attenuation providing said high isolation.

23. The antenna of claim 22, wherein said low frequency band radiator comprises at least first and second radiating elements having a reactive element electrically connecting them, the reactive element configured to alter an electric size of the low frequency band radiator within the high frequency band so as to allow said low frequency band radiator to reinforce radiation of said high frequency band radiator within said high frequency band.

24. A multiband antenna structure of a radio device which has resonances both in a low band and a high band, comprising:
a main radiator having an operating band in the low band;
a second radiator and a parasitic radiator having an operating band in the high band, the parasitic radiator being located between the main radiator and the second radiator;
a ground plane comprising a signal ground for the radio device; and
a matching circuit connected to a feed point of the multiband antenna structure, the matching circuit comprising a serial resonance circuit configured to implement a double resonance for the main radiator in the range of the low band and further configured to enhance the isolation between the main radiator and the second radiator;
wherein a slot radiator is in the main radiator to provide an additional resonance in the high band; and
wherein a reactive element joins the main radiator to decrease the electric size of the main radiator at the frequencies of the high band for strengthening resonances in the high band and to increase the electric size of the main radiator at the frequencies of the low band for widening the low operating band.

25. The antenna structure of claim 24, wherein the main radiator comprises:
starting from its feed point, a first and a second part separated from each other by a non-conductive gap;
wherein the reactive element is an inductive element, one end of which is in the first part and the other end in the second part of the main radiator; and
wherein the slot radiator is located in the first part, a slot of the slot radiator opening to an edge of the main radiator next to its feed point.

26. The antenna structure of claim 25, wherein the inductance of the inductive element is at least 10 nH.

27. The antenna structure of claim 24, wherein the main radiator comprises:
starting from its feed point, a first part and a last part so that a starting end of the first part and a tail end of the last part are relatively close to each other;
wherein the reactive element is a capacitive element, the capacitance of which exists between the starting end of the first part and the tail end of the last part, primarily to decrease the electric size of the main radiator at the frequencies of the high band for strengthening resonances in the high band.

28. The antenna structure of claim 24, wherein the main radiator is located on a surface of a support frame, and comprises an oblong conductor strip having a longitudinal direction and a width direction, the width direction being substantially perpendicular to the geometric plane determined by the ground plane.

29. The antenna structure of claim 28, wherein the second radiator comprises a conductor coating of a ceramic substrate, the second radiator and the ceramic substrate constituting a chip component which is located on the surface of the support frame.

30. The antenna structure of claim 24, wherein the main radiator, the second radiator and the parasitic radiator are formed of a conductor coating of a dielectric support frame.

31. The antenna structure of claim 24, wherein the additional resonance is located in the frequency range of 2500-2690 MHz for a WCDMA7 system.
